(19) United States
(12) Patent Application Publication
(10) Pub. No.: US 2020/0181329 A1
(43) Pub. Date: Jun. 11, 2020

(54) RENEWABLE FURAN BASED POLYIMIDES FOR COMPOSITE APPLICATIONS

(71) Applicants: DREXEL UNIVERSITY, Philadelphia, PA (US); The Government of the United States of America, as represented by The Secretary of the Army, Washington, DC (US)

(72) Inventors: Giuseppe R. Palmese, Hainesport, NJ (US); Santosh K. Yadav, Geneva, OH (US); John J. LaScala, Wilimington, DE (US)

(73) Assignees: Drexel University, Philadelphia, PA (US); The Government of the United States of America, as represented by The Secretary of the Army, Washington, DC (US)

(21) Appl. No.: 16/637,568

(22) PCT Filed: Aug. 21, 2018
(86) PCT No.: PCT/US18/47188

§ 371 Date: Feb. 7, 2020

Related U.S. Application Data
(60) Provisional application No. 62/547,954, filed on Aug. 21, 2017.

(51) Int. Cl. C08G 73/10; C08K 7/14

(52) U.S. Cl. CPC C08G 73/1085; C08K 7/14; C08G 73/1007

(57) ABSTRACT

A renewable polyimide or polyamic acid formed from a reaction comprising one or more furfurylamine compounds of Formula (I) or Formula (II) and one or more dianhydride or diacid compounds and heating to a temperature of up to 350° C., as well as methods of forming thereof, and polymers comprising the polyimide or polyamic acid compounds. The renewable furan based polyimides which demonstrate excellent processability, large temperature windows for processing of resin systems, and are less toxic.

### CROSS REFERENCE TO RELATED APPLICATIONS

This application claims the benefit of U.S. Provisional Application No. 62/547,954, filed on Aug. 21, 2017, the entire disclosure of which is hereby incorporated by reference as if set forth fully herein.

### STATEMENT OF GOVERNMENT INTEREST

This invention was made with government support under Contract Number W911NF-15-2-0017 awarded by the United States Army Research Laboratory. The Government has certain rights in this invention.

### FIELD OF THE INVENTION

The present invention relates to a series of the renewable furan based polyimides which demonstrate excellent processability, large temperature windows for processing of resin systems, and are less toxic.

### BACKGROUND

The PMR-15 polyimide resin developed by NASA is an excellent matrix resin for composite systems for lightweight hot structures in aerospace and several other applications due to its long term thermooxidative stability and robust mechanical properties including fracture toughness and resistance to micro-cracking [1-3]. However, the PMR-15 resin system has several issues which need to be addressed, particularly the high toxicity of the amine monomer, 4-4′methylenedianiline (MDA). Renewable alternatives to replace MDA in the polymerization of monomer reactants (PMR) to prepare polyimides have attracted significant attention due to their health, economic, and environmental impact. Recent research efforts have focused on bio based building blocks as a promising potential source for industrially relevant, building block molecules [4].

One of the three components of plant cell walls, lignin is a rigid, amorphous aromatic biopolymer produced by dry land plants. During pulp and paper production processes, the cellulose and hemicellulose are desired, while lignin is typically burned for cheap energy recovery. However, the use of bio based building block for the development of polyimides has been limited. Furanyl building blocks are primarily derived from polysaccharides and sugars, and can be used for preparing amine monomers [5-8]. In an attempt to develop alternative amine monomers for PMR-15 resin systems to reduce the toxicity and improve processability and characteristic properties of the polyimides, methods incorporating a furan based amine moiety into the structure have been developed and are described herein.

### SUMMARY OF THE INVENTION

In accordance with the disclosure, exemplary embodiments provide polyimide and polyamic acid compounds formed from a furfurylamine and one or more dianhydride or diacid compounds, methods of forming thereof, and polymers comprising the polyimide or polyamic acid compounds.

The following are sentences describing embodiments of the invention.

1. A polyimide or polyamic acid formed from a reaction of one or more furfurylamine compounds of Formula (I) or Formula (II) and one or more dianhydride or diacid compounds and heating to a temperature of up to 350° C.,

wherein the compound of Formula (I) may be a difuran diamine compound having the following structure,

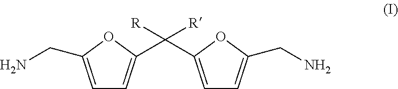

wherein R and R¹ are independently selected from hydrogen, an optionally substituted alkyl group having 1 to 20 carbon atoms, an optionally substituted alkene group having 2 to 20 carbon atoms, an optionally substituted cycloalkyl group having 3 to 12 carbon atoms, an optionally substituted aryl group having 6 to 16 carbon atoms, and an optionally substituted heterocyclic group having 3 to 16 carbon atoms; wherein the alkyl group, alkene group, cycloalkyl group, aryl group or heterocyclic group can be substituted with 1 to 5 substituents independently selected from a halogen, hydroxy, amino, nitro, cyano, carboxy, an alkyl group having 1 to 20 carbons, a heterocyclic group having 3 to 16 carbons, and an alkoxy group having 1 to 20 carbon atoms;

wherein the compound of Formula (II) may be a tetrafuran tetramine compound with the following structure,

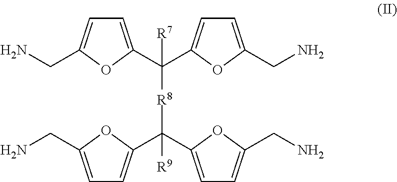

wherein R⁷ and R⁹ may independently be selected from hydrogen, an optionally substituted alkyl group having 1 to 20 carbon atoms, an optionally substituted alkene group having 2 to 20 carbon atoms, an optionally substituted heterocyclic group with 3 to 15 carbon atoms, optionally substituted aryl group having 6 to 15 carbon atoms and an optionally substituted cycloalkyl group having 3 to 12 carbon atoms; wherein the alkyl group, alkene group, heterocyclic group, aryl group, or cycloalkyl group can be substituted with 1 to 5 substituents independently selected from a halogen, hydroxy, amino, nitro, cyano, carboxy, an alkyl group having 1 to 20 carbons, an aryl group having 6 to 15 carbon atoms, a heterocyclic group having 3 to 16 carbons, and an alkoxy group having 1 to 20 carbon atoms, and wherein the aryl group substituent and the heterocyclic group substituent can be further substituted with hydroxy, an alkoxy group having 1 to 20 carbon atoms, or an alkylamino group having 1 to 2 carbon atoms; and

R⁸ may be an optionally substituted alkylene group having 1 to 20 carbon atoms, an optionally substituted alkenylene group having 2 to 20 carbon atoms, an optionally substituted heterocyclic group with 3 to 15 carbon atoms, optionally substituted arylene group having 6 to 15 carbon atoms and an optionally substituted cycloalkylene group having 3 to 12 carbon atoms; wherein the alkylene group, alkenylene group, heterocyclic group, arylene group, or cycloalkylene group can be substituted with 1 to 4 substituents independently selected from a halogen, hydroxy, amino, nitro, cyano, carboxy, an alkyl group having 1 to 20 carbons, a heterocyclic group having 3 to 16 carbons, and an alkoxy group having 1 to 20 carbon atoms.

2. The polyimide or polyamic acid of sentence 1, wherein R and R¹ may be each independently selected from:

hydrogen, an optionally substituted alkyl group having 7 to 20 carbon atoms, an optionally substituted alkene group having 3 to 20 carbon atoms, an optionally substituted cycloalkyl group having 3 to 12 carbon atoms and a phenyl group of the following structure:

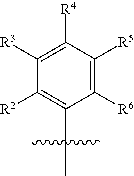

wherein the alkyl group, alkene group, or cycloalkyl group can be substituted with 1 to 5 substituents independently selected from a heterocyclic group having 3 to 16 carbons, a hydroxyl group, and an alkoxy group having 1 to 20 carbon atoms;

wherein

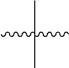

represents the attachment point to the methylene carbon bridging the furan rings in Formula (I); R², R³, R⁴, R⁵, and R⁶ are independently selected from hydrogen, a hydroxyl group, an alkoxy group having 1 to 20 carbon atoms, an optionally substituted alkyl group having 1 to 20 carbon atoms, an optionally substituted alkene group having 2 to 20 carbon atoms, an optionally substituted aryl group having 6 to 10 carbon atoms, an optionally substituted heterocyclic group having 3 to 9 carbon atoms, and an optionally substituted cycloalkyl group having 3 to 12 carbon atoms; wherein the optionally substituted alkyl group, alkene group, aryl group, heterocyclic group, or cycloalkyl group can be substituted with 1 to 5 substituents independently selected from a hydroxyl group, an alkoxy group, and a heterocyclic group having 1 to 20 carbon atoms; wherein at least one of R², R³, R⁴, R⁵ and R⁶ is not a hydrogen when one of R and R¹ is hydrogen, and wherein only one of R and R¹ can be a hydrogen.

3. The polyimide or polyamic acid of sentence 1, wherein R may be hydrogen; R¹ may be selected from a phenyl group of the following structure:

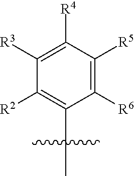

wherein

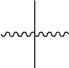

represents the attachment point to the methylene carbon bridging the furan rings in Formula (I); R², R³, R⁴, R⁵, and R⁶ are independently selected from hydrogen, a hydroxyl group, an alkoxy group having 1 to 4 carbon atoms, an alkyl group having 1 to 6 carbon atoms, an alkene group having 2 to 4 carbon atoms; wherein at least one of R², R³, R⁴, R⁵ and R⁶ is not a hydrogen.

4. The polyimide or polyamic acid of sentence 1, wherein R and R¹ may be each independently selected from hydrogen, an optionally substituted alkyl group having 8 to 18 carbon atoms, an optionally substituted alkene group having 4 to 18 carbon atoms, and an optionally substituted cycloalkyl group having 3 to 8 carbon atoms, wherein the alkyl group, alkene group, or cycloalkyl group can be substituted with 1 to 5 substituents independently selected from a halogen, hydroxy, amino, nitro, cyano, carboxy, an alkyl group having 1 to 8 carbons, and an alkoxy group having 1 to 8 carbon atoms; and only one of R and R¹ can be a hydrogen.

5. The polyimide or polyamic acid of sentence 1, wherein the furfurylamine compound may be a tetrafuran tetramine compound of Formula (II):

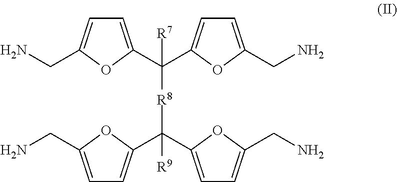

wherein R⁷ and R⁹ may be independently selected from hydrogen, an optionally substituted alkyl group having 1 to 18 carbon atoms, an optionally substituted alkene group having 2 to 18 carbon atoms, an optionally substituted heterocyclic group with 3 to 8 carbon atoms, optionally substituted aryl group having 6 to 9 carbon atoms and an optionally substituted cycloalkyl group having 3 to 12 carbon atoms; wherein the alkyl group, alkene group, heterocyclic group, aryl group, or cycloalkyl group can be substituted with 1 to 5 substituents independently selected from a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms; and
R⁸ may be selected from an optionally substituted alkylene group having 1 to 18 carbon atoms, an optionally substituted alkenylene group having 2 to 18 carbon atoms, an optionally substituted heterocyclic group with 3 to 8 carbon atoms, optionally substituted arylene group having 6 to 9 carbon atoms and an optionally substituted cycloalkylene group having 3 to 12 carbon atoms; wherein the alkylene group, alkenylene group, heterocyclic group, arylene group, or cycloalkylene group can be substituted with 1 to 4 substituents independently selected from a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms.

6. The polyimide or polyamic acid of sentence 1, wherein the furfurylamine compound may be a tetrafuran tetramine compound of Formula (II):

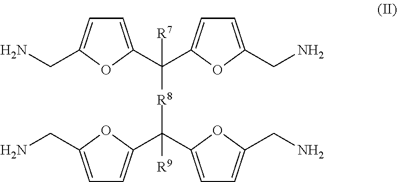

wherein R⁷ and R⁹ may be independently selected from hydrogen, an optionally substituted alkyl group having 1 to 8 carbon atoms, an optionally substituted alkene group having 2 to 8 carbon atoms, an optionally substituted heterocyclic group with 3 to 6 carbon atoms, optionally substituted aryl group having 6 to 9 carbon atoms and an optionally substituted cycloalkyl group having 3 to 8 carbon atoms; wherein the alkyl group, alkene group, heterocyclic group, aryl group, or cycloalkyl group can be substituted with 1 to 5 substituents independently selected from a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms; and
R⁸ may be selected from an optionally substituted alkylene group having 1 to 8 carbon atoms, an optionally substituted alkenylene group having 2 to 8 carbon atoms, an optionally substituted heterocyclic group with 3 to 6 carbon atoms, optionally substituted arylene group having 6 to 9 carbon atoms and an optionally substituted cycloalkylene group having 3 to 8 carbon atoms; wherein the alkylene group, alkenylene group, heterocyclic group, arylene group, or cycloalkylene group can be substituted with 1 to 4 substituents independently selected from a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms.

7. The polyimide or polyamic acid of any one of sentences 1-6, wherein in R, R¹, R², R³, R⁴, R⁵, R⁶, R⁷ and R⁹

the alkyl group may be selected from a straight or branched chain butyl, pentyl, hexyl, heptyl, octyl, nonyl, decyl, undecyl and dodecyl,

the alkene group may be selected from a vinyl, propenyl, or a straight or branched chain butenyl, pentenyl, hexenyl, heptenyl, octenyl, nonenyl, decenyl, undecenyl and dodecenyl,

the cycloalkyl group may be selected from a cyclopentyl or cyclohexyl,

the aryl group may be selected from phenyl, tolyl, and biphenyl,

the heterocyclic group may be selected from pyrrolidine, pyrrole, tetrahydrofuran, furan, tetrahydrothiophene, thiophene, imidazolidine, pyrazolidine, imidazole, pyrazole, oxazolidine, isoxazolidine, oxazole, isoxazole, thiazolidine, isothiazolidine, thiazole, isothiazole, dioxolane, dithiolane, piperidine, pyridine, bipyridine, tetrahydropyran, pyran, piperazine, diazines, morpholine, oxazine, thiomorpholine, and thiazine;

wherein in R⁸

the alkylene group may be selected from a straight or branched chain butylene, pentylene, hexylene, heptylene, octylene, nonylene, decylene, undecylene and dodecylene,

the alkenylene group may be selected from a vinylene, propenylene, or a straight or branched chain butenylene, pentenylene, hexenylene, heptenylene, octenylene, nonenylene, decenylene, undecenylene and dodecenylene,

the cycloalkylene group may be selected from a cyclopentylene or cyclohexylene,

the arylene group may be selected from phenylene, tolylene, and biphenylene; and

wherein the groups are optionally substituted with 1-4 substituents and the optional substituents are selected from the group consisting of an alkyl group having 1 to 3 carbons, an aldehyde, a hydroxyl group and methoxy group.

8. The polyimide or polyamic acid of sentence 1, wherein there may be a 1:2 to 2:1 molar ratio of the one or more difuran-diamine monomers to the one or more dianhydride or diacid compounds.

9. The polyimide or polyamic acid of sentence 1, wherein there may be a 1:1.1 to 1.1:1 molar ratio of the one or more difuran-diamine monomers to the one or more dianhydride or diacid compounds.

10. The polyimide of sentence 1, including at least one repeat unit of Formula (III):

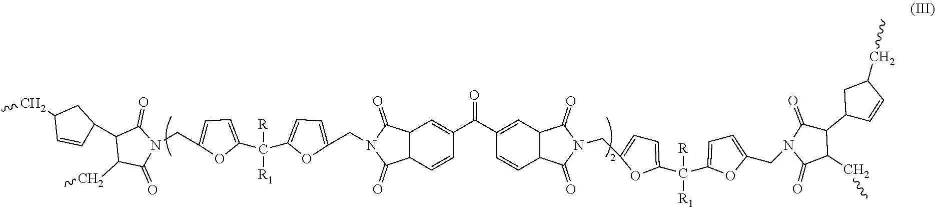

wherein R and R₁ are defined in sentence 1; and the symbol [symbol] denotes a covalent bond to another repeat unit.

11. The polyamic acid of sentence 1 having the following Formula (IV):

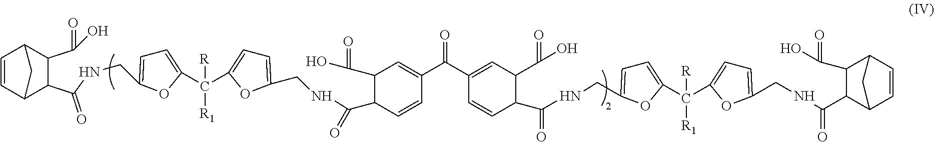

wherein R and R₁ are as defined in sentence 1.

12. A method of forming the polyimide or polyamic acid of sentence 1, including combining one or more furfurylamine compounds of Formula (I) or Formula (II) as defined in sentence 1; and one or more comonomers selected from any dianhydride or dimethyl ester thereof including but not limited to

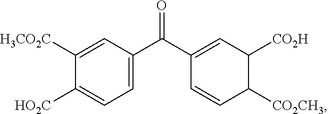 [SMILES: COC(=O)c1cc(C(=O)C2=CC(C(=O)O)C(C(=O)OC)C=C2)ccc1C(=O)O]

3,3′,4,4′-Benzophenonetetracarboxylic dianhydride (BTDA) or a diester thereof (BTDE) 3FDA, 4,4′-(2,2,2-trifiuoro-1-phenylethylidene) diphthalic anhydride or a dimethyl ester thereof; PEPA, 4-phenylethynylphthalic anhydride;
BPDA, 3,3′,4,4′-biphenyl-tetracarboxylic dianhydride or dimethyl ester thereof;
DPEB,3,5-diamino-4′-phenylethynyl benzophenone;
6FDA, 4,4′-(1,1,1,3,3,3-hexafioroisopropylidene) diphthalic anhydride or dimethyl ester thereof;
8FDA, 4,4′-(2,2,2-trifluoro-1-pentafiuorophenylethylidene) dipthalic anhydride;
BTDA, 3,3′-4,4′-benzophenone tetracarboxylic acid dianhydride or dimethyl ester thereof;
BNDA, 4,4-bis (1,1-binapthyl-2-oxy, 1,1′ -binepthyl-2,2′-oxy) dipthalic anhydride or dimethyl ester; BAPPNE, dimethyl ester of 5-norbornene 1,2-dicarboxylic acid;
PBDA, 4,4′-(1,1′-biphenyl-2-oxy) diphthalic anhydride or dimethyl ester thereof;
BPADA, 2,2′-bis(phenoxy isopropylidene) 4,4-diphthalic anhydride;
Bisphenol A-4,4′-diphthalic anhydride; PDMDA, 3,3′-bis (3,4-dicarboxyphenoxy) diphenylmethane dianhydride; and 2,2′,-BPDA, 2,2′,3,3′,-biphenyltetracarboxylic dianhydride or dimethylester thereof; and

optionally any unsaturated mono anhydride or methyl ester thereof; including but not limited to:

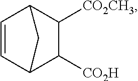 [SMILES: COC(=O)C1C2C=CC(C2)C1C(=O)O]

nadic anhydride (NA) or a methyl ester (NE) thereof; phenylethynyl, maleic anhydride, acetylene functionalized anhydride or methyl ester thereof; vinyl functionalized anhydride or methyl ester thereof; nitrile containing anhydride or methyl ester thereof; phenylacetylene containing anhydride or methyl ester thereof, phathalonitrile containing anhydride or methyl ester thereof, biphenylene containing anhydride or methyl ester thereof, and benzocylobutene containing anhydride or methyl ester thereof, and

heating to a temperature of up to 350° C.

13. The method of forming the polyimide or polyamic acid according to sentence 12, wherein the one or more furfurylamine compounds of Formula (I) or Formula (II) and dianhydride monomers may be heated in the presence of at least one organic solvent.

14. The method of forming the polyimide or polyamic acid according to sentence 13, wherein the organic solvent may be selected from dimethylacetamide, acetonitrile, ethyl acetate, isopropyl acetate, hydrocarbon alcohols such as methanol, ethanol, propanol and the like; polar substances such as dimethylsulfoxide, dimethylformamide, N-methyl-2-pyrrolidone and the like; aromatic hydrocarbons such as toluene, xylene, benzene and the like; organic ethers such as t-butyl methyl ether, dimethoxy ethane, 2-methoxyethyl ether, methyl cellosolve, ethyl cellosolve, cellosolve acetate and the like; ketone hydrocarbons such as methyl ethyl ketone, acetone, cyclohexanone, methyl isobutyl ketone and the like; hydrocarbons containing chlorine such as methylene chloride, ethylene chloride, tetrachloroethane, trichloroethylene, trichloroethane; furan hydrocarbons such as tetrahydrofuran, dioxane and the like; and mixtures thereof.

15. The method of forming the polyamic acid according to sentence 12, may include a step of stirring the one or more furfurylamine compounds of Formula (I) or Formula (II) and BTDE at room temperature.

16. The method of forming the polyamic acid according to sentence 12, may include stirring the one or more furfurylamine compounds of Formula (I) or Formula (II), NE, and BTDE at room temperature.

17. The method of forming the polyamic acid according to sentence 12, may further include a step wherein the one or more furfurylamine compounds of Formula (I) or Formula (II), NE and BTDE combine to form the polyamic acid of Formula (IV):

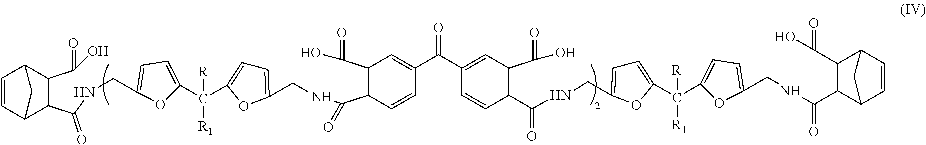

wherein R and R₁ are as defined in sentence 1.

18. A method of forming a polyimide, including removing water and methanol from the polyamic acid of sentence 17 to form an intermediate of Formula (V)

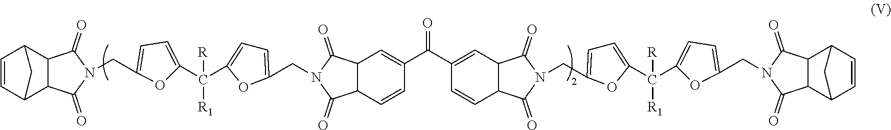

wherein R and R₁ are as defined in sentence 1.

19. The method of forming the polyamic acid according to sentence 12, may further include a step wherein the one or more furfurylamine compounds of Formula (I) or Formula (II), and one or more comonomers which are dianhydrides or methyl esters thereof combine to form the polyamic acid while using stoichiometric ratios of anhydride/methyl anhydride relative the amine to produce a linear polymer with molecular weight of 10,000 g/mol or higher.

20. A method of forming a polyimide, including removing water and methanol from the polyamic acid of sentence 19 to form a linear polyamide with molecular weight of 10,000 g/mol or higher.

21. The method of forming the polyimide according to sentence 20, may further include a step of conversion of the intermediate of Formula (V) to the polyimide of Formula (III) with heat, or at a temperature of 100-315° C.

22. The method of forming the polyimide according to any one of sentences 18-21, wherein the step of forming the polyamic acid of Formula (IV) is performed at a temperature of up to 150° C. or a temperature of 80-150° C.

23. The method of forming the polyimide according to sentence 22, wherein the step of forming the intermediate of Formula (V) is performed at a temperature of above 100° C. to 250° C. while under vacuum.

24. The method of forming the polyamic acid according to sentence 11, may further include a step of forming BTDE by combining 3,3′,4,4′-benzophenonetetracarboxylic dianhydride with methanol or anhydrous methanol.

25. The method according to sentence 13, wherein the NE, the one or more furfurylamine compounds of Formula (I) or Formula (II) (DFDA) and BTDE may be combined in a molar ratio of about 2NE/3.087DFDA/2.087BTDE. “DFDA” is 5,5,-methylenedifurfurylamine.

26. The polyimide of sentence 1 or the method of sentence 25, wherein the polyimide may have at least one of the following properties:
i. Tg=200-380° C., or 280-300° C.;
ii. Mass degradation up to 350° C. of less than 5 wt %;
iii. Char yield=60% or greater; and
iv. Number average molecular weight=up to 2000 g/mole.

27. The polyamic acid of sentence 1 or the method of sentence 25, wherein the polyamic acid may have at least one of the following properties:
i. Melt temperature=80-180° C.;
ii. Temperature of onset of crosslinking=150-350° C. or 200-275° C.;
iii. Mass degradation up to 350° C. of up to 15 wt %;
   wherein the mass degradation were taken at 1° C./min ramp rate from 25 to 800° C.

28. A polymer composition comprising the polyimide or polyamic acid of sentence 1, may further include one or more of fibers, clays, silicates, fillers, whiskers, pigments, corrosion inhibitors, flow additives, film formers, defoamers, coupling agents, antioxidants, stabilizers, flame retardants, reheating aids, plasticizers, flexibilizers, anti-fogging agents, nucleating agents, and combinations thereof.

29. The polymer composition according to sentence 28, comprising the pigment, the corrosion inhibitor and the fibers and wherein the pigment may be titanium dioxide, iron oxides, carbon black or mixtures thereof; the corrosion inhibitor is zinc phosphate; and the fibers are glass fibers or carbon fibers.

Additional details and advantages of the disclosure will be set forth in part in the description which follows, and/or may be learned by practice of the disclosure. The details and advantages of the disclosure may be realized and attained by means of the elements and combinations particularly pointed out in the appended claims.

### BRIEF DESCRIPTION OF THE DRAWINGS

FIG. 1 shows the Dynamic Mechanical Analysis (DMA) thermograms of DFDA based polyamic acid/glass fiber composite and CH₃-DFDA based polyamic acid/glass fiber prepared via melt press at 140° C.

FIG. 2 shows the DMA thermograms of B-DFDA and V-DFDA based polyamic acid/glass fiber composite prepared via melt press at 140° C.

FIG. 3 shows the melt temperature and crosslink onset temperature of polyamic acid/glass fiber composites prepared via melt pressing at 140° C.

FIGS. 4A-4B show the DMA thermograms of DFDA based polyimide/glass fiber composite (FIG. 4A) first scan; (FIG. 4B) second scan.

FIGS. 5A-5B show the DMA thermograms of CH₃-DFDA based polyimide/glass fiber composite (FIG. 5A) first scan; (FIG. 5B) second scan.

FIGS. 6A-6B show the DMA thermograms of benzyl-DFDA based polyimide/glass fiber composite (FIG. 6A) first scan; (FIG. 6B) second scan.

FIGS. 7A-7B show the DMA thermograms of V-DFDA based polyimide/glass fiber composite (FIG. 7A) first scan; (FIG. 7B) second scan.

FIGS. 8A-8B show the Thermogravimetric analysis (TGA) thermograms of cured samples of polyamic acid in argon and air environment.

FIGS. 9A-9B show the TGA thermograms of cured samples of polyimides in argon and air environment.

FIGS. 10A-10B show an image of polyimide/glass fiber composites (FIG. 10A) and films of polyamic acid (FIG. 10B).

FIG. 11 shows the moisture absorptions of the DFDA based polyamic acid. PMR/CH₃-DFDA, PMR/DFDA and PMR 15.

### DETAILED DESCRIPTION OF THE EXEMPLARY EMBODIMENTS

Disclosed herein are polyimide or polyamic acid formed from a reaction of one or more furfurylamines and one or more dianhydride or diacid compounds.

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other systems and methods. Before explaining the disclosed embodiments of the present invention in detail, it is to be understood that the invention is not limited in its application to the details of any particular embodiment shown. Additionally, the terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

As used herein and in the appended claims, the singular forms “a”, “an”, and “the” include plural references unless the context clearly dictates otherwise. The terms “a” (or “an”), “one or more” and “at least one” can be used interchangeably herein. It is also to be noted that the terms “comprising”, “including”, and “having” can be used interchangeably.

As used herein “room temperature” refers to a temperature of 18° C.

### Polyamides and Polyamic Acids and Preparations Thereof

In one embodiment, the polyimide or polyamic acids may be formed from a reaction of one or more furfurylamine compounds of Formula (I) or Formula (II) and one or more dianhydride or diacid compounds and heating to a temperature of up to 350° C.,

wherein the compound of Formula (I) is a difuran diamine compound having the following structure,

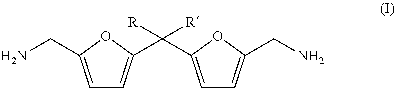

wherein R and R¹ are independently selected from hydrogen, an optionally substituted alkyl group having 1 to 20 carbon atoms, an optionally substituted alkene group having 2 to 20 carbon atoms, an optionally substituted cycloalkyl group having 3 to 12 carbon atoms, an optionally substituted aryl group having 6 to 16 carbon atoms, and an optionally substituted heterocyclic group having 3 to 16 carbon atoms; wherein the alkyl group, alkene group, cycloalkyl group, aryl group or heterocyclic group can be substituted with 1 to 5 substituents independently selected from a halogen, hydroxy, amino, nitro, cyano, carboxy, an alkyl group having 1 to 20 carbons, a heterocyclic group having 3 to 16 carbons, and an alkoxy group having 1 to 20 carbon atoms;

wherein the compound of Formula (II) is a tetrafuran tetramine compound with the following structure,

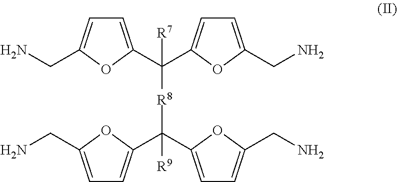

wherein R⁷ and R⁹ are independently selected from hydrogen, an optionally substituted alkyl group having 1 to 20 carbon atoms, an optionally substituted alkene group having 2 to 20 carbon atoms, an optionally substituted heterocyclic group with 3 to 15 carbon atoms, optionally substituted aryl group having 6 to 15 carbon atoms and an optionally substituted cycloalkyl group having 3 to 12 carbon atoms; wherein the alkyl group, alkene group, heterocyclic group, aryl group, or cycloalkyl group can be substituted with 1 to 5 substituents independently selected from a halogen, hydroxy, amino, nitro, cyano, carboxy, an alkyl group having 1 to 20 carbons, an aryl group having 6 to 15 carbon atoms, a heterocyclic group having 3 to 16 carbons, and an alkoxy group having 1 to 20 carbon atoms, and wherein the aryl group substituent and the heterocyclic group substituent can be further substituted with hydroxy, an alkoxy group having 1 to 20 carbon atoms, or an alkylamino group having 1 to 2 carbon atoms; and

R⁸ is an optionally substituted alkylene group having 1 to 20 carbon atoms, an optionally substituted alkenylene group having 2 to 20 carbon atoms, an optionally substituted heterocyclic group with 3 to 15 carbon atoms, optionally substituted arylene group having 6 to 15 carbon atoms and an optionally substituted cycloalkylene group having 3 to 12 carbon atoms; wherein the alkylene group, alkenylene group, heterocyclic group, arylene group, or cycloalkylene group can be substituted with 1 to 4 substituents independently selected from a halogen, hydroxy, amino, nitro, cyano, carboxy, an alkyl group having 1 to 20 carbons, a heterocyclic group having 3 to 16 carbons, and an alkoxy group having 1 to 20 carbon atoms.

In another embodiment, R and R¹ are each independently selected from:

hydrogen, an optionally substituted alkyl group having 7 to 20 carbon atoms, an optionally substituted alkene group having 3 to 20 carbon atoms, an optionally substituted cycloalkyl group having 3 to 12 carbon atoms and

a phenyl group of the following structure:

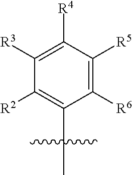

wherein the alkyl group, alkene group, or cycloalkyl group can be substituted with 1 to 5 substituents independently selected from a heterocyclic group having 3 to 16 carbons, a hydroxyl group, and an alkoxy group having 1 to 20 carbon atoms;

wherein

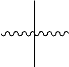

represents the attachment point to the methylene carbon bridging the furan rings in Formula (I); R², R³, R⁴, R⁵, and R⁶ are independently selected from hydrogen, a hydroxyl group, an alkoxy group having 1 to 20 carbon atoms, an optionally substituted alkyl group having 1 to 20 carbon atoms, an optionally substituted alkene group having 2 to 20 carbon atoms, an optionally substituted aryl group having 6 to 10 carbon atoms, an optionally substituted heterocyclic group having 3 to 9 carbon atoms, and an optionally substituted cycloalkyl group having 3 to 12 carbon atoms; wherein the optionally substituted alkyl group, alkene group, aryl group, heterocyclic group, or cycloalkyl group can be substituted with 1 to 5 substituents independently selected from a hydroxyl group, an alkoxy group, and a heterocyclic group having 1 to 20 carbon atoms; wherein at least one of R², R³, R⁴, R⁵ and R⁶ is not a hydrogen when one of R and R¹ is hydrogen, and wherein only one of R and R¹ can be a hydrogen.

In another embodiment, R is hydrogen; R¹ selected from a phenyl group of the following structure:

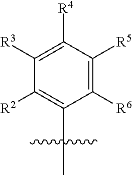

wherein

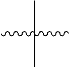

represents the attachment point to the methylene carbon bridging the furan rings in Formula (I); R², R³, R⁴, R⁵, and R⁶ are independently selected from hydrogen, a hydroxyl group, an alkoxy group having 1 to 4 carbon atoms, an alkyl group having 1 to 6 carbon atoms, an alkene group having 2 to 4 carbon atoms; wherein at least one of R², R³, R⁴, R⁵ and R⁶ is not a hydrogen.

In another embodiment, R and R¹ are each independently selected from:

hydrogen, an optionally substituted alkyl group having 8 to 18 carbon atoms, an optionally substituted alkene group having 4 to 18 carbon atoms, and an optionally substituted cycloalkyl group having 3 to 8 carbon atoms, wherein the alkyl group, alkene group, or cycloalkyl group can be substituted with 1 to 5 substituents independently selected from a halogen, hydroxy, amino, nitro, cyano, carboxy, an alkyl group having 1 to 8 carbons, and an alkoxy group having 1 to 8 carbon atoms; and only one of R and R¹ can be a hydrogen.

In another embodiment, the furfurylamine compound is a tetrafuran tetramine compound of Formula (II):

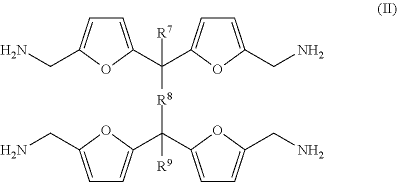

wherein R⁷ and R⁹ are independently selected from hydrogen, an optionally substituted alkyl group having 1 to 18 carbon atoms, an optionally substituted alkene group having 2 to 18 carbon atoms, an optionally substituted heterocyclic group with 3 to 8 carbon atoms, optionally substituted aryl group having 6 to 9 carbon atoms and an optionally substituted cycloalkyl group having 3 to 12 carbon atoms; wherein the alkyl group, alkene group, heterocyclic group, aryl group, or cycloalkyl group can be substituted with 1 to 5 substituents independently selected from a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms; and

R⁸ is selected from an optionally substituted alkylene group having 1 to 18 carbon atoms, an optionally substituted alkenylene group having 2 to 18 carbon atoms, an optionally substituted heterocyclic group with 3 to 8 carbon atoms, optionally substituted arylene group having 6 to 9 carbon atoms and an optionally substituted cycloalkylene group having 3 to 12 carbon atoms; wherein the alkylene group, alkenylene group, heterocyclic group, arylene group, or cycloalkylene group can be substituted with 1 to 4 substituents independently selected from a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms.

In another embodiment, the furfurylamine compound is a tetrafuran tetramine compound of Formula (II):

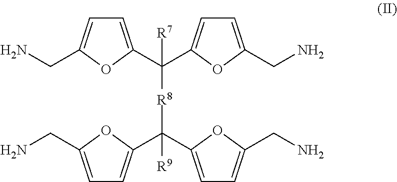

wherein R⁷ and R⁹ are independently selected from hydrogen, an optionally substituted alkyl group having 1 to 8 carbon atoms, an optionally substituted alkene group having 2 to 8 carbon atoms, an optionally substituted heterocyclic group with 3 to 6 carbon atoms, optionally substituted aryl group having 6 to 9 carbon atoms and an optionally substituted cycloalkyl group having 3 to 8 carbon atoms; wherein the alkyl group, alkene group, heterocyclic group, aryl group, or cycloalkyl group can be substituted with 1 to 5 substituents independently selected from a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms; and

R⁸ is selected from an optionally substituted alkylene group having 1 to 8 carbon atoms, an optionally substituted alkenylene group having 2 to 8 carbon atoms, an optionally substituted heterocyclic group with 3 to 6 carbon atoms, optionally substituted arylene group having 6 to 9 carbon atoms and an optionally substituted cycloalkylene group having 3 to 8 carbon atoms; wherein the alkylene group, alkenylene group, heterocyclic group, arylene group, or cycloalkylene group can be substituted with 1 to 4 substituents independently selected from a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms.

In each of the foregoing embodiments, R, R¹, R², R³, R⁴, R⁵, R⁶, R⁷ and R⁹ may each independently be selected from
an alkyl group is selected from a straight or branched chain butyl, pentyl, hexyl, heptyl, octyl, nonyl, decyl, undecyl and dodecyl,
an alkene group is selected from a vinyl, propenyl, or a straight or branched chain butenyl, pentenyl, hexenyl, heptenyl, octenyl, nonenyl, decenyl, undecenyl and dodecenyl,
an cycloalkyl group is selected from a cyclopentyl or cyclohexyl,
an aryl group is selected from phenyl, tolyl, and biphenyl,
an heterocyclic group is selected from pyrrolidine, pyrrole, tetrahydrofuran, furan, tetrahydrothiophene, thiophene, imidazolidine, pyrazolidine, imidazole, pyrazole, oxazolidine, isoxazolidine, oxazole, isoxazole, thiazolidine, isothiazolidine, thiazole, isothiazole, dioxolane, dithiolane, piperidine, pyridine, bipyridine, tetrahydropyran, pyran, piperazine, diazines, morpholine, oxazine, thiomorpholine, and thiazine;
   wherein in R⁸
an alkylene group is selected from a straight or branched chain butylene, pentylene, hexylene, heptylene, octylene, nonylene, decylene, undecylene and dodecylene,
an alkenylene group is selected from a vinylene, propenylene, or a straight or branched chain butenylene, pentenylene, hexenylene, heptenylene, octenylene, nonenylene, decenylene, undecenylene and dodecenylene,
an cycloalkylene group is selected from a cyclopentylene or cyclohexylene, an arylene group is selected from phenylene, tolylene, and biphenylene; and

wherein the groups are optionally substituted with 1-4 substituents and the optional substituents are selected from the group consisting of an alkyl group having 1 to 3 carbons, an aldehyde, a hydroxyl group and methoxy group.

The polyimide or polyamic acid may have a molar ratio of the one or more difurandiamine monomers to the one or more dianhydride or diacid compound of from 1:2 to 2:1, or from 1:1.1 to 1.1:1.

In one embodiment, the polyimide includes at least one repeat unit of Formula (III) or the polyamic acid has the following Formula (IV):

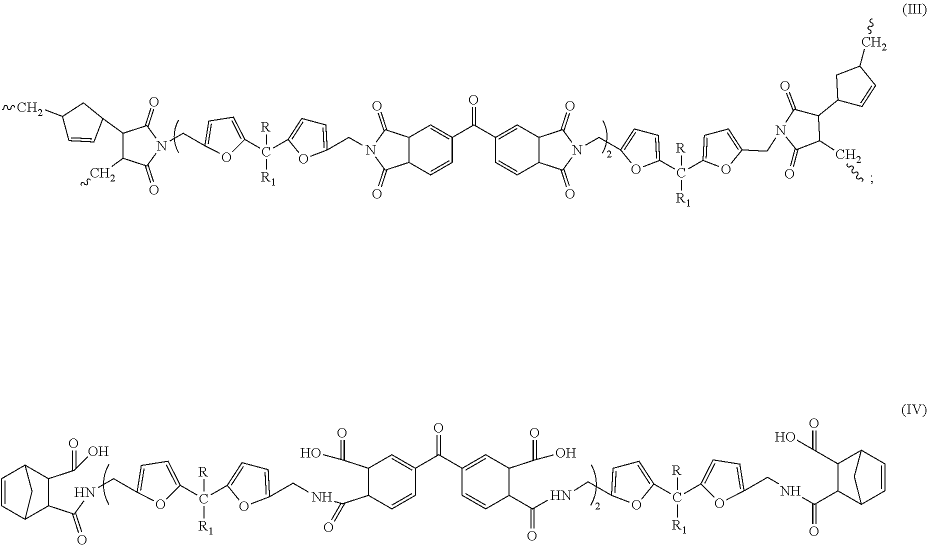

wherein R and R₁ are the same as set forth above; and the symbol [symbol] denotes a covalent bond to another repeat unit.

In another aspect, the present invention relates to methods of forming the polyimide or polyamic acid, which includes combining one or more furfurylamine compounds of Formula (I) as set forth above, and one or more comonomers selected from any dianhydride or dimethyl ester, and heating to a temperature of up to 350° C.

Suitable dianhydrides and diesters may be selected from but not limited to

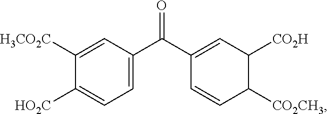 [SMILES: COC(=O)c1cc(C(=O)C2=CC(C(=O)O)C(C(=O)OC)C=C2)ccc1C(=O)O]

3,3′,4,4′-Benzophenonetetracarboxylic dianhydride (BTDA) or diester thereof (BTDE) 3FDA, 4,4′-(2,2,2-trifiuoro-1-phenylethylidene) diphthalic anhydride or dimethyl ester thereof;
PEPA, 4- phenylethynylphthalic anhydride; BPDA, 3,3′,4,4′-biphenyl-tetracarboxylic dianhydride or dimethyl ester thereof; DPEB,3,5-diamino-4′-phenylethynyl benzophenone;
6FDA, 4,4′-(1,1,1,3,3,3-hexafioroisopropylidene) diphthalic anhydride or dimethyl ester thereof; 8FDA, 4,4′-(2,2,2-trifluoro-1-pentafiuorophenylethylidene) dipthalic anhydride;
BTDA, 3,3′-4,4′-benzophenone tetracarboxylic acid dianhydride or dimethyl ester thereof;
BNDA, 4,4-bis (1,1-binapthyl-2-oxy, 1,1′-binepthyl-2,2′-oxy) dipthalic anhydride or dimethyl ester; BAPPNE, dimethyl ester of 5-norbornene 1,2-dicarboxylic acid;
PBDA, 4,4′-(1,1′-biphenyl-2-oxy) diphthalic anhydride or dimethyl ester thereof;
BPADA, 2,2′-bis(phenoxy isopropylidene) 4,4′-diphthalic anhydride;
Bisphenol A-4,4′-diphthalic anhydride; PDMDA, 3,3′-bis (3,4-dicarboxyphenoxy) diphenylmethane dianhydride; and 2,2′,-BPDA, 2,2′,3,3′,-biphenyltetracarboxylic dianhydride or dimethylester thereof; and optionally any unsaturated mono anhydride or methyl ester thereof; including but not limited to:

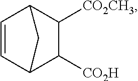 [SMILES: COC(=O)C1C2C=CC(C2)C1C(=O)O]

nadic anhydride (NA) or methyl ester (NE) thereof; phenylethynyl, maleic anhydride, acetylene functionalized anhydride or methyl ester thereof; vinyl functionalized anhydride or methyl ester thereof; nitrile containing anhydride or methyl ester thereof; phenylacetylene containing anhydride or methyl ester thereof, phathalonitrile containing anhydride or methyl ester thereof, biphenylene containing anhydride or methyl ester thereof, and benzocylobutene containing anhydride or methyl ester thereof. Wherein the method for preparing the polyimide or polyamic acid includes methyl ester (NE), one or more furfurylamine compounds of Formula (I) or Formula (II), and 3,3′,4,4′-Benzophenonetetracarboxylic (BTDE), the NE, the furfurylamine, and the BTDE are combined in a molar ratio of about 2:3.087:2.087.

The method of preparing the polyimide or polyamic acid may further including heating the one or more furfurylamine compounds of Formula (I) or Formula (II) and the dianhydride monomers in the presence of at least one organic solvent.

Suitable organic solvents may be selected from dimethylacetamide, acetonitrile, ethyl acetate, isopropyl acetate, hydrocarbon alcohols such as methanol, ethanol, propanol and the like; polar substances such as dimethylsulfoxide, dimethylformamide, N-methyl-2-pyrrolidone and the like; aromatic hydrocarbons such as toluene, xylene, benzene and the like; organic ethers such as t-butyl methyl ether, dimethoxy ethane, 2-methoxyethyl ether, methyl cellosolve, ethyl cellosolve, cellosolve acetate and the like; ketone hydrocarbons such as methyl ethyl ketone, acetone, cyclohexanone, methyl isobutyl ketone and the like; hydrocarbons containing chlorine such as methylene chloride, ethylene chloride, tetrachloroethane, trichloroethylene, trichloroethane; furan hydrocarbons such as tetrahydrofuran, dioxane and the like; and mixtures thereof.

The foregoing method, when forming a polyamic acid may further include a step of stirring the one or more furfurylamine compounds of Formula (I) or Formula (II) and 3,3′,4,4′-benzophenonetetracarboxylic diester (BTDE) at room temperature. Alternatively, the method for forming a polyamic acid may further include stirring the one or more furfurylamine compounds of Formula (I) or Formula (II), NE, and BTDE at room temperature. Alternatively, the method for forming a polyamic acid may further include a step of forming BTDE by combining 3,3′,4,4′-benzophenonetetracarboxylic dianhydride with methanol or anhydrous methanol. Alternatively, the method for forming a polyamic acid may further include a step wherein the one or more furfuylamine compounds of Formula (I) or Formula (II), NE and BTDE combine to form the polyamic acid of Formula (IV):

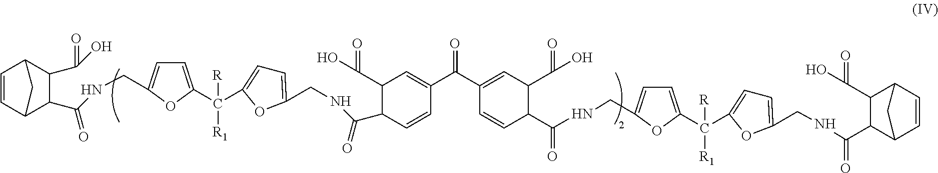

wherein R and R₁ are the same as set forth above. Alternatively, the method for forming a polyamic acid may further include a step wherein the one or more furfurylamine compounds of Formula (I) or Formula (II), and one or more comonomers which are dianhydrides or methyl esters thereof combine to form a polyamic acid while using stoichiometric ratios of anhydride/methyl anhydride relative to the amine to produce linear polymer with a molecular weight of 10,000 g/mol or higher.

In another embodiment, the method of forming the polyimide may include removing water and methanol from the polyamic acid of the foregoing embodiment to form a linear polyamide with a molecular weight of 10,000 g/mol or higher. The foregoing embodiment may further include a step of converting the intermediate of Formula (V) to the polyimide of Formula (III) with heat, or at a temperature of 100 to 315° C.

In another embodiment, the method for forming the polyimide may include removing water and methanol from the polyamic acid of Formula (IV) to form an intermediate of Formula (V):

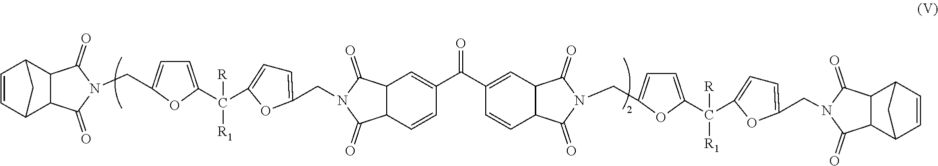

wherein R and R₁ are the same as set forth above. In another embodiment, the method may further include a step of converting the intermediate of Formula (V) to a polyimide of Formula (III) with heat, or at a temperature of 100° C. to 315° C.

Embodiments directed to a method of forming the polyimide and include the step of forming the polyamic acid of Formula (IV) may be carried out at a temperature of up to 150° C., or a temperature of from 80° C. to 150° C. In the foregoing embodiment, the step of forming the intermediate of Formula (IV) may be carried out at a temperature of greater than 100° C. to 250° C. while under vaccum.

The polyimides of the present invention preferably exhibit at least one of the following properties:
a) a glass transition temperature (T_{g}) of from 200° C. to 380° C., or from 280° C. to 300° C.;
b) mass degradation up to 350° C., of less than 5 wt. %;
c) Char yield of 60% or greater; and
d) A number average molecular weight of up to 2,000 g/mole.

The polyamic acids of the present invention preferably exhibit at least one of the following properties:
a) A melt temperature of from 80° C. to 180° C.;
b) A temperature of onset of crosslinking of from 150° C. to 350° C., or from 200° C. to 275° C.;
c) Mass degradation of up to 350° C., of up to 15 wt. %, wherein the mass degradation was taken at 1° C./min ramp rate of from 25° C. to 800° C.

In another aspect, the present invention relates to polymer compositions comprising the polyimide or polyamic acid as set forth above, wherein the polymer composition further includes one or more fibers, clays, silicates, fillers, whiskers, pigments, corrosion inhibitors, flow additives, film formers, defoamers, coupling agents, antioxidants, stabilizers, flame retardants, reheating aids, plasticizers, flexibilizers, anti-fogging agents, nucleating agents, and combinations thereof. Preferably, the polymer composition includes pigment, corrosion inhibitors, and fibers, wherein the pigment is selected from titanium dioxide, iron oxides, carbon black or mixtures thereof; the corrosion inhibitor is zinc phosphate; and the fibers are glass fibers or carbon fibers.

### Fire Retardancy

Improved fire retardancy may be attained by incorporating into a polyimide, an ammonium or amine salt of a phosphonic or a phosphinic acid. Such a composition is then applied to a suitable substrate, such as glass cloth, to form a “prepreg”, and the polyimide is cured to obtain a fire resistant composite or laminate. The term “a phosphonic or phosphinic acid” is also intended to include thiophosphonic and thiophosphinic acids.

Such compounds are soluble in the polyimide, and upon curing of the resin composition and composite containing such compounds or additives, there is no adverse effect on the mechanical properties of the cured composite or laminate. Such composite offers substantial protection against burning, particularly at high temperatures, e.g. at 2,000° F. At such temperatures, e.g. a 2,000° F. flame condition, the presence of a sufficient amount of the above additive in the composite results in stabilization of the resin char which is formed. This enables such char to hold the fibers of the substrate, e.g. glass or graphite fibers, together and maintain the structural stability and integrity of the composite or laminate. The resin char also has reduced thermal conductivity due to the heat dissipation capability of the carbonaceous residue.

### Timing of Addition of Additives

When it is intended to make a molded object or to fill a chopped fiber or to form a matrix resin or to form a coating material or to form a paint by mixing a pigment, it is desirable to use a polyimide prepolymer such as the polyamic acid of Formula (II). It is also possible to combine the monomers which are dissolved in a low boiling point solvent such as alcohol or the like and impregnating a fiber to convert to the polyamic acid of Formula (II) in situ to obtain an intermediate material for molding, or the polyamic acid of Formula (II) is dissolved in a low boiling point solvent such as alcohol, and the resulting solution is impregnated on a fiber to obtain an intermediate material for molding.

With respect to the reinforcing fiber in the fiber-reinforced resin composite material using the polyimide resin of the present invention, any fiber which is used as a reinforcing fiber for an ordinary fiber-reinforced resin composite material such as a carbon fiber, glass fiber and various organic fibers can be used, and the reinforcing fiber may be used in any form such as a bundle oriented in one direction, a fabric, a knit and the like. Further, a hybrid of a carbon fiber with glass fiber or a carbon fiber with them may be used, and there is no limitation.

### Casting Solvent

The “casting solvent” herein refers to a solvent which is used as a solvent in a case where a coating film, a formed article, or the like of a polymer is formed by preparing a solution of the polymer and applying the solution onto a substrate, and which can be removed from the polymer solution by vapor diffusion after the casting. As the “casting solvent,” a solvent different from the organic solvent (polymerization solvent) used for the polymerization is preferably used in terms of vapor diffusivity and removability after the casting.

The casting solvent is not particularly limited, and halogen-containing solvents having boiling points of 200° C. or below are preferable, dichloromethane (boiling point: 40° C.), trichloromethane (boiling point: 62° C.), carbon tetrachloride (boiling point: 77° C.), dichloroethane (boiling point: 84° C.), trichloroethylene (boiling point: 87° C.), tetrachloroethylene (boiling point: 121° C.), tetrachloroethane (boiling point: 147° C.), chlorobenzene (boiling point: 131° C.), o-dichlorobenzene (boiling point: 180° C.) are more preferable, and dichloromethane (methylene chloride) and trichloromethane (chloroform) are further preferable, from the viewpoints of solubility, volatility, vapor diffusivity, removability, film formability, productivity, industrial availability, recyclability, the presence or absence of existing facility, and price. Note that one of these casting solvents may be used alone, or two or more thereof may be used in combination.

In addition, the polyimide for casting is particularly preferably one soluble in one or both of methylene chloride (boiling point: 40° C.) and chloroform (boiling point: 62° C.) from the viewpoint of the processability.

### Reaction Accelerator

A “reaction accelerator” may used for conversion of the polyamic acid to a polyimide by condensation, and a known compound can be used, as appropriate. The reaction accelerator can also function as an acid scavenger that captures the acid by-produced during the reaction. For this reason, the use of the reaction accelerator accelerates the reaction and suppresses the reverse reaction due to the by-produced acid, so that the reaction can be caused to proceed efficiently. The reaction accelerator is not particularly limited, and is more preferably one also having a function of an acid scavenger. Examples of the reaction accelerator include tertiary amines such as triethylamine, diisopropylethylamine, N-methylpiperidine, pyridine, collidine, lutidine, 2-hydroxypyridine, 4-dimethylaminopyridine (DMAP), 1,4-diazabicyclo[2.2.2]octane (DABCO), diazabicyclononene (DBN), and diazabicycloundecene (DBU), and the like. Of these reaction accelerators, triethylamine, diisopropylethylamine, N-methylpiperidine, and pyridine are preferable, triethylamine, pyridine, and N-methylpiperidine are more preferable, and triethylamine and N-methylpiperidine are further preferable from the viewpoints of reactivity, availability, and practicability. One of those reaction accelerators may be used alone or two or more thereof may be used in combination.

### EXAMPLES

The following examples are illustrative, but not limiting of the methods and compositions of the present disclosure.

### Materials

The following materials were employed throughout the examples.

Furfurylamine (99%), hydrochloric acid (37%), chloroform, formaldehyde solution (37%), sodium hydroxide (98%), tetrahydrofuran (THF, 99.9%), anhydrous methanol (99.8%) were supplied by Sigma-Aldrich, USA, 3,3′,4,4′-benzophenonetetracarboxylic dianhydride (BTDA), 5-norbornene-2, 3-dicarboxylic acid (NE) were obtained from TCI chemical, USA, respectively. All chemicals were used as received. DFDA was synthesized and purified as described in the literature [4].

### Characterization

Dynamic mechanical analysis (DMA) and thermogravimetric analysis (TGA) were used to investigate the thermal and mechanical properties of cured samples. DMA samples were tested using a TA Q800 DMA in single cantilever geometry with a 1 Hz frequency, 15 μm amplitude and 2° C./min ramp rate from 25 to 400° C. Each sample was tested twice and the first and second both scan were reported, the first scan was used to obtain its glass transition temperature (T_{g}). A TA Q50 TGA was employed to investigate the thermal stability of samples in argon and air environment by heating from 25° C. to 800° C. with 1° C./min ramp rate.

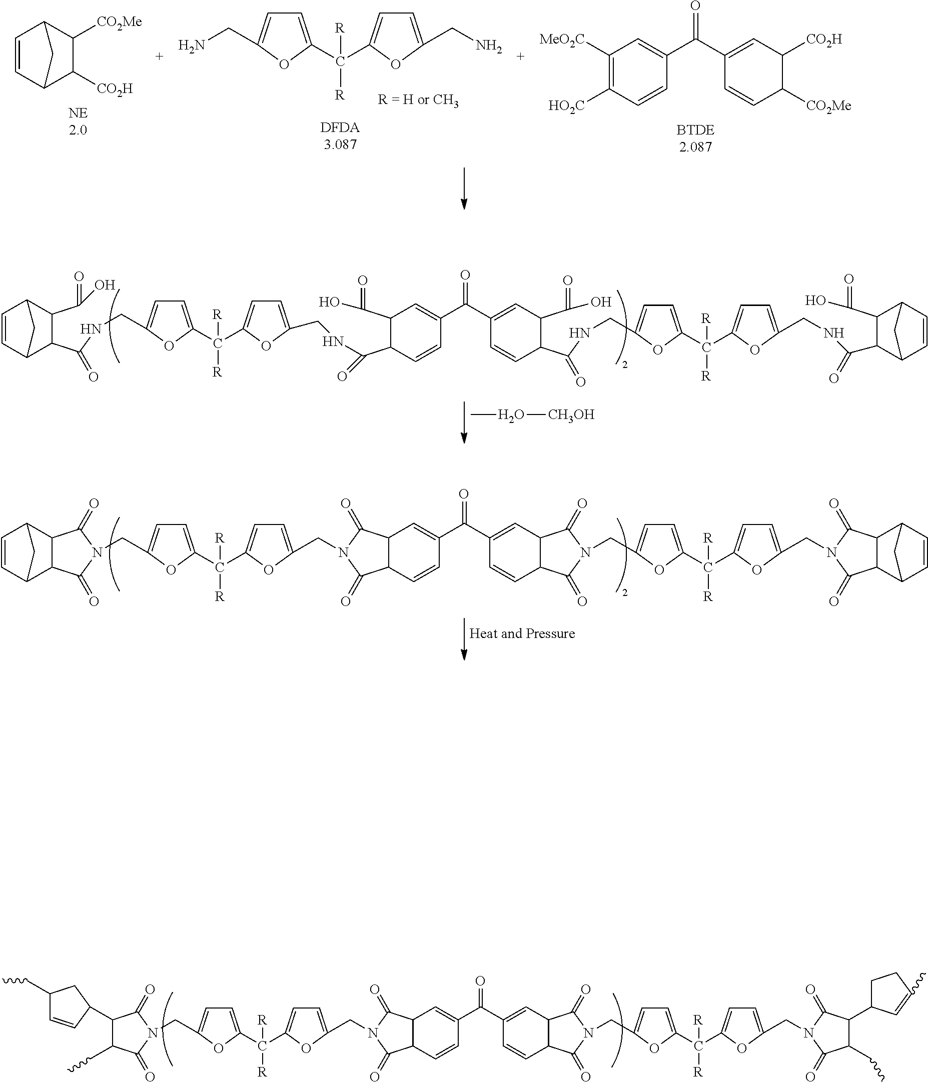

### Synthetic Scheme for the Curing of Furan Based Polyimides

### Preparation of Polyamic Acids

In the classic method of polyimide synthesis, a tetracarboxylic acid dianhydride is added to a solution of diamine in a polar aprotic solvent. The generated poly(amic acid) is then cyclodehydrated to the corresponding polyimide by extended heating at elevated temperatures. Since the polyimide is often insoluble, the polymer is usually processed in the form of the poly(amic acid), which is thermally imidised in place. PMR-15 is Polymerization of the Monomer Reactants MDA, 5-norbornene-2,3′-dicarboxylic half acid ester (NE), and 3,3′,4,4′-benzophenonetetracarboxylic diester (BTDE). MDA, NE, and BTDE are dissolved in alcohols, such as methanol, at 50 wt % and “staged” to enable imidization to form pre-polymers. The molar ratio of 2:2.087:3.087 NE/BTDE/MDA is used to form the idealized structure in with a molecular weight of ˜1500 g/mol. We prepared the poly amic acid using furan based amines. The same protocol of PMR-15 was adapted to prepare furan based polyamic acid. The monomethyl ester of 5-norbornene-2, 3-dicarboxylic acid (NE) is used as an end cap. The dimethyl ester of 3,3′,4,4′-benzophenonetetracarboxylic acid (BTDE) chain extender was prepared as a 50 weight percent solution by refluxing a suspension of the 3,3′,4,4′-benzophenonetetracarboxylic dianhydride (BTDA) in anhydrous methanol for 3 hours. The monomer stoichiometry for the polyamic acid solution was 2NE/3.087DFDA derivatives/2.087BTDE. Further the polyamic acid was prepared by adding the 50 weight percent solution of DFDA derivatives in anhydrous THF (DFDA and CH₃-DFDA) or methanol (Benzyl-DFDA) to the 50 weigh percent solution of BTDE and NE in anhydrous methanol and further the solution was stirred at the room temperature for 6 h. Further the solvent was evaporated in vacuum oven at 120° C.

### Preparation of Polyamic Acids/Glass Fiber Composites

The polyamic acid and glass fiber composites were prepared via solution method. We prepared the 50 weight percent solution of polyamic acid in DMF solvent and calculated amount of glass fiber were dipped for 4 times in the solution. The solvent was evaporated in vacuum oven at 120° C. and the samples were cured at 315° C. for 4 h under the vacuum condition. All the sample have the approximately 50 weight percent of the polymer contents.

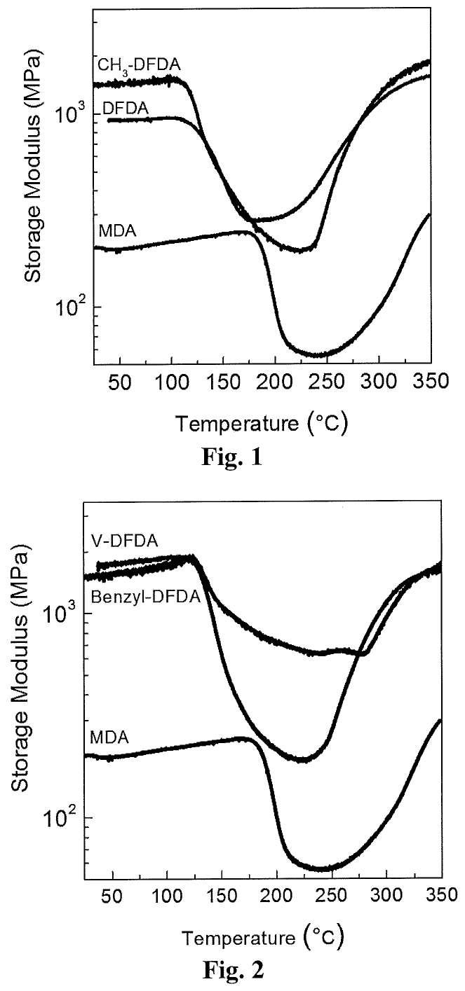

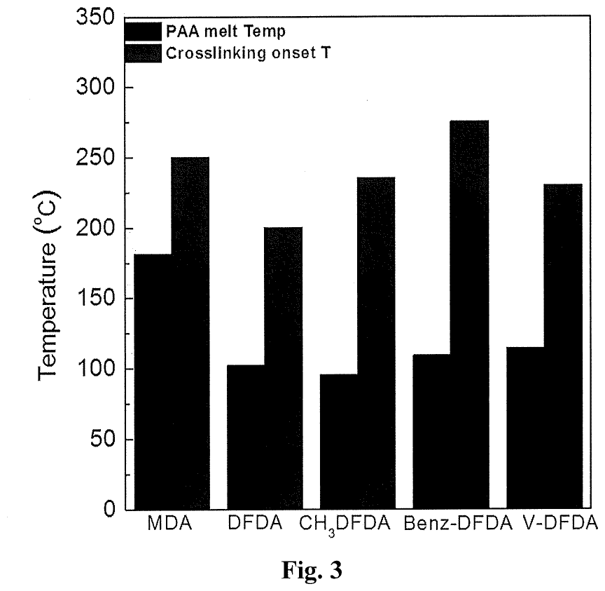

The samples of furan based polyimic acid/glass fiber composites for cure kinetics study were prepared via melt press at 120 to 140° C. The thermal profiles obtained from the DMA measurement of polyamic acid and glass fiber composites showed curing kinetic behavior of polyimide composites (FIG. 1 and FIG. 2). The initial sharp loss of storage modulus of DFDA-PPA/glass fiber, CH₃-DFDA-PAA/glass fiber, Benzyl-DFDA-PPA/glass fiber and V-DFDA-PAA/glass fiber composites around 100-120° C. results from the melt of the oligoimides (FIG. 1 and FIG. 2). It is evident that the chemical reaction leading to chain extension does not occur below 100° C. It suggest that the furan based oligoimides have large temperature window for processing of resin systems compared to the MDA based systems (FIG. 3). Further the storage modulus of MDA-PAA/glass fiber, DFDA-PAA/glass fiber, CH₃-DFDA-PAA/glass fiber, Benzyl-DFDA-PPA/glass fiber and V-DFDA-PAA/glass fiber composites tends to increase around 250, 200, 230, 275, 230° C. respectively, which reflect the occurrence of thermally activated chemical reactions with in the matrix networks lead to further crosslinking and other form of matrix developments.

The samples were cured at 315° C. for 4 h to evaluate the actual glass transition temperature of the polyimide and glass fiber composites network. Representative data, characteristics of the glass transitions of the resins containing various furan based diamines are presented in Table 1. All the polyimide/glass fiber composites show broad peak of loss modulus and tan delta peak.

TABLE 1
Tgs of polyimides/glass fiber composites.

| Sample Code | Loss Modulus Tg | Tan Delta Tg |
|---|---|---|
| DFDA-PAA/glass fiber_1^{st} run | 334 | 348 |
| DFDA-PAA/glass fiber_2^{nd} run | 358 | 375 |
| CH₃-DFDA-PAA/glass fiber_1^{st} run | 331 | 350 |
| CH₃-DFDA-PAA/glass fiber_2^{nd} run | 352 | 378 |
| Benzyl-DFDA-PAA/glass fiber_1^{st} run | 309 | 330 |
| Benzyl-DFDA-PAA/glass fiber_2^{nd} run | 367 | 370 |

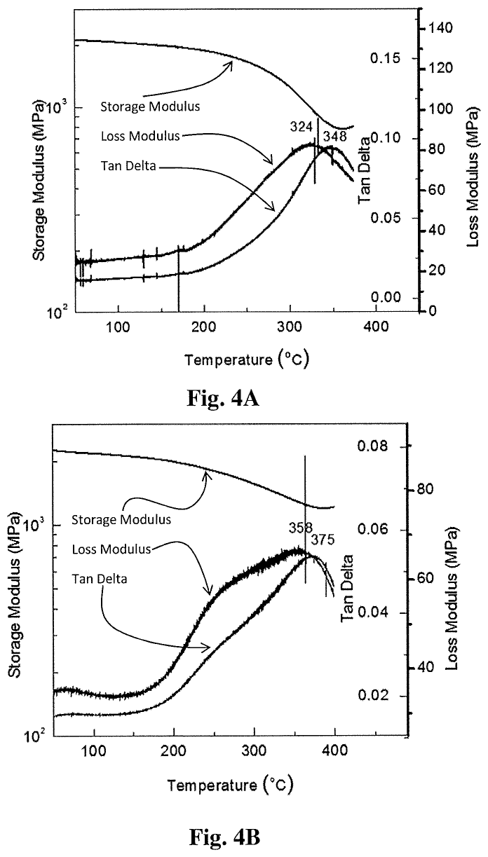

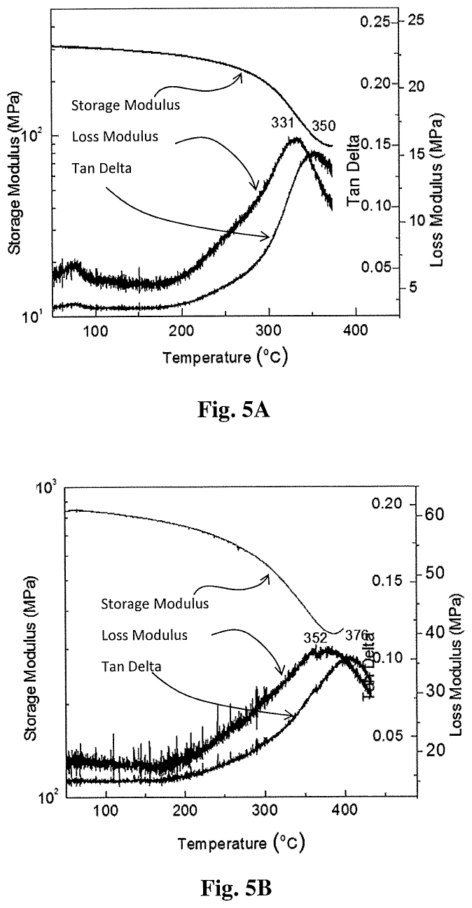

The DFDA-polyimide/glass fiber composite showed the loss modulus Tg at 334° C. and Tan delta Tg at 348° C. in the first scan, however in the second scan the loss modulus and Tan delta Tgs goes up to 358 and 375° C. respectively with 6.8 wt % mass degradation (FIGS. 4A-4B). Similar behavior was observed for CH₃-DFDA-polyimide/glass fiber composites (FIGS. 5A-5B). The first scan loss modulus and Tan delta Tg was observed at 331 and 350° C. These Tg values increased to 352 (loss modulus) and 378° C. (Tan delta) respectively with the 7 wt % weight loss.

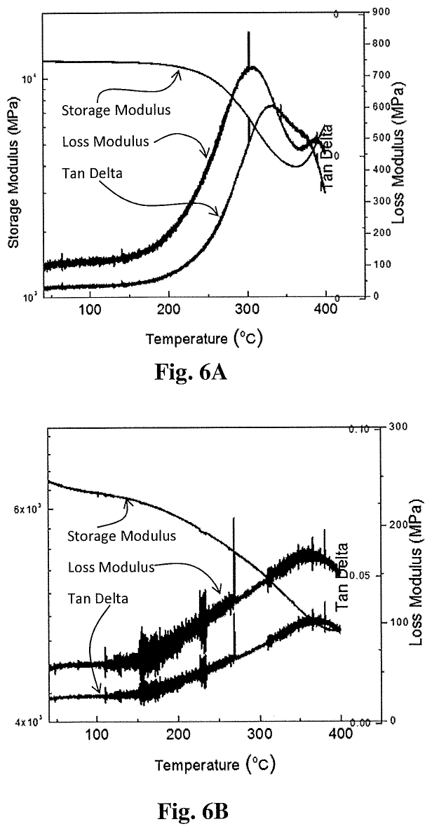

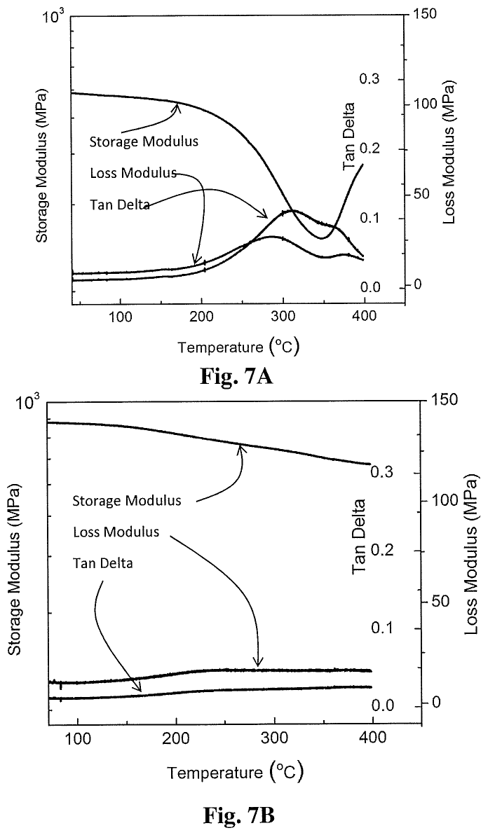

Benzyl-DFDA-polyimide/glass fiber composites showed interesting low loss modulus Tg at 309° C. and Tan delta Tg 330° C. in first scan and further enhancement was observed of storage modulus at higher temperature (350° C.), indicating the further crosslinking (FIGS. 6A-6B). However, higher Tg (loss modulus Tg 367 and Tan delta Tg 370° C.) was observed in second scan with 6.2 wt % of polymer degradation. Further, the storage modulus of V-DFDA-polyimides/glass fiber composites (FIGS. 7A-7B) showed tends to increase around 350° C. which reflect the occurrence of further crosslinking, suggest that that polymer is not fully cured. In the second heating, any transition was observed before 400° C. The storage modulus obtained in such experiments are unimportant in characterizing the mechanical behavior each polyimide/glass fiber composites, and do not facilitate the comparison of one imides with another.

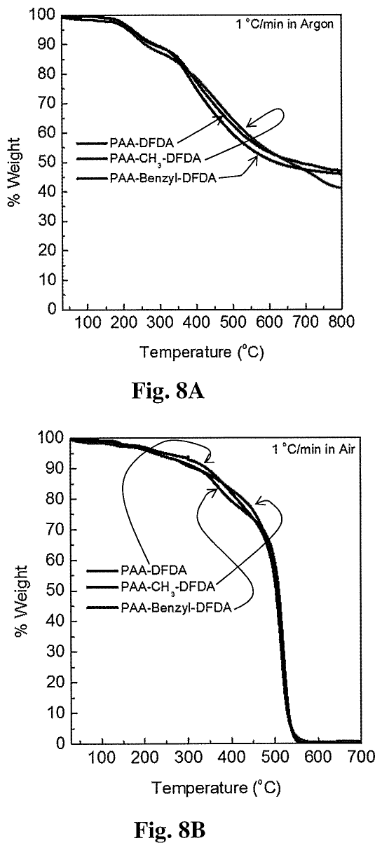

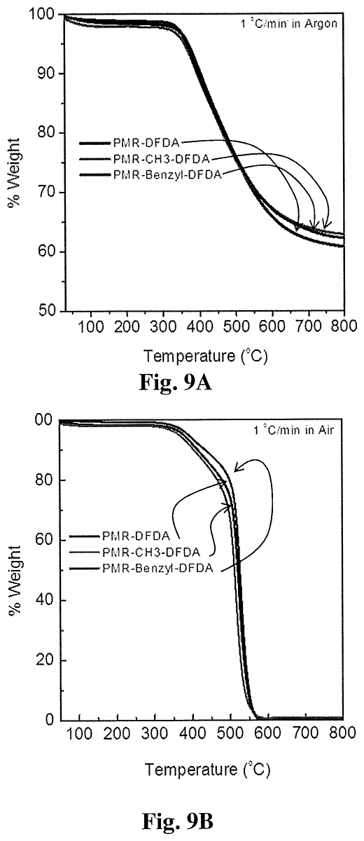

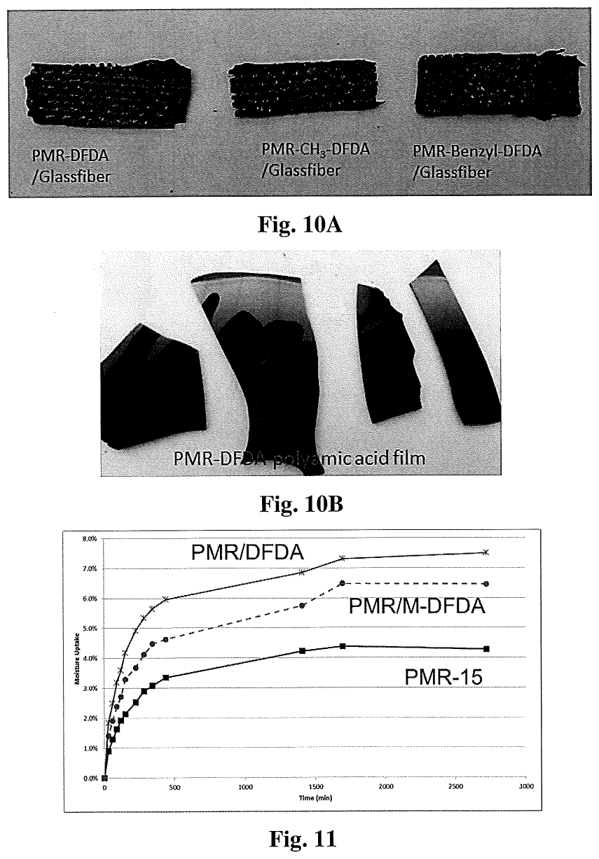

Thermogravimetric analysis (TGA) was used to investigate thermal properties of polyamic acid and polyimides of furan based diamines (DFDA, CH₃-DFDA and Benzyl-DFDA) in air and argon environment. Experiments were conducted under both air and nitrogen atmospheres. Temperature ramps were implemented between 25° C. and 800° C. at a rate of 1° C./min. The mass loss curves are plotted in FIGS. 8A-8B and FIGS. 9A-9B for the polyamic acids and polyimides. The TGA curves show similar degradation behavior for all the furan based polyaimic acids (FIGS. 8A-8B). Polyimides were prepared via theimal curing of polyamic acid, in which two types of chemical reactions dehydration/amidization around 80-150° C. and cyclization/imidaization above 150° C. involved. The furan based polyamic acids showed the 10 wt % and 15wt % degradation before 350° C. in both air and argon respectively, which is attribute to evolving of moisture and dehydration/amidization as well as cyclization/imidaization reactions. However, furan based polyimides samples cured at 315° C. did not show any degradation before 350° C. (FIGS. 9A-9B). High char yields was obtained for both polyamic acid (40%) and polyimide (60%), which is associated with the furanyl monomers could prove advantageous for applications regarding high-temperature durability. Images showing the high quality of these composites and films of these polyimides are shown in FIGS. 10A-10B.

Also shown is the moisture absorption of the DFDA based polyamic acid. PMR/CH₃-DFDA and PMR/DFDA absorb more moisture than PMR-15.

Further a series of novel furan based aromatic polyimides were prepared via the PMR approach and incorporating furan based diamines in the main chain. Polyimide/glass fiber composites were also prepare via solution method and properties of composites were evaluated using the DMA and TGA. Further, imidization and crosslinking reaction profiles of furan based polyimides and glass fiber composites have been delineated using DMA, and thermomechanical properties of the composites investigated. Glass transition temperatures (>300° C.) are apparent in composites systems while maintaining the thermal integrity.

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes, or at least for the purpose described in the context in which the reference was presented.

### Reference

The following references may be useful in understanding some of the principles discussed herein:

[1] Wilson D. PMR-15 processing, properties and problems—a review. British Polymer Journal. 1988;20:405-16.

[2] Jigajinni V B, Preston P N, Shah V K, Simpson S W, Soutar I, Stewart N J. Structure-property relationships in PMR-15-type polyimide resins: IIH. New polyimides incorporating triazoles, quinoxalines, pyridopyrazines and pyrazinopyridazines. High Performance Polymers. 1993;5:239-57.

[3] St. Clair A K, St. Clair T L. Structure-property relationships of isomeric addition polyimides containing nadimide end groups. Polymer Engineering & Science. 1976;16:314-7.

[4] Scola D A, Vontell J H. High temperature polyimides, chemistry and properties. Polymer Composites. 1988;9:443-52.

[5] Mitiakoudis A, Gandini A. Synthesis and characterization of furanic polyamides. Macromolecules. 1991;24:830-5.

[6] Froidevaux V, Negrell C, Caillol S, Pascault J-P, Boutevin B. Biobased Amines: From Synthesis to Polymers; Present and Future. Chemical Reviews. 2016;116:14181-224.

[7] Yadav S K, Hu F, La Scala J J, Sadler J M, Yandek G, Palmese G R. Preparation and characterization of novel furan-based polyimides. International SAMPE Technical Conference 2016.

[8] Yandek G R, Lamb J T, La Scala J J, Harvey B G, Palmese G R, Eck W S, et al. Balancing performance and sustainability in next-generation PMR technologies for OMC structures. International SAMPE Technical Conference 2016.

1. A polyimide or polyamic acid formed from a reaction comprising one or more furfurylamine compounds of Formula (I) or Formula (II) and one or more dianhydride or diacid compounds and heating to a temperature of up to 350° C.,
wherein the compound of Formula (I) is a difuran diamine compound having the following structure, 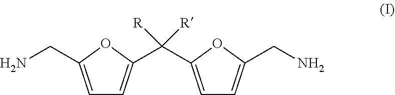
wherein R and R¹ are independently selected from the group consisting of hydrogen, an optionally substituted alkyl group having 1 to 20 carbon atoms, an optionally substituted alkene group having 2 to 20 carbon atoms, an optionally substituted cycloalkyl group having 3 to 12 carbon atoms, an optionally substituted aryl group having 6 to 16 carbon atoms, and an optionally substituted heterocyclic group having 3 to 16 carbon atoms; wherein the alkyl group, alkene group, cycloalkyl group, aryl group or heterocyclic group can be substituted with 1 to 5 substituents independently selected from the group consisting of a halogen, hydroxy, amino, nitro, cyano, carboxy, an alkyl group having 1 to 20 carbons, a heterocyclic group having 3 to 16 carbons, and an alkoxy group having 1 to 20 carbon atoms;
wherein the compound of Formula (II) is a tetrafuran tetramine compound with the following structure, 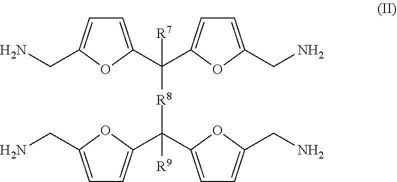
wherein R⁷ and R⁹ are independently selected from the group consisting of hydrogen, an optionally substituted alkyl group having 1 to 20 carbon atoms, an optionally substituted alkene group having 2 to 20 carbon atoms, an optionally substituted heterocyclic group with 3 to 15 carbon atoms, optionally substituted aryl group having 6 to 15 carbon atoms and an optionally substituted cycloalkyl group having 3 to 12 carbon atoms; wherein the alkyl group, alkene group, heterocyclic group, aryl group, or cycloalkyl group can be substituted with 1 to 5 substituents independently selected from the group consisting of a halogen, hydroxy, amino, nitro, cyano, carboxy, an alkyl group having 1 to 20 carbons, an aryl group having 6 to 15 carbon atoms, a heterocyclic group having 3 to 16 carbons, and an alkoxy group having 1 to 20 carbon atoms, and wherein the aryl group substituent and the heterocyclic group substituent can be further substituted with hydroxy, an alkoxy group having 1 to 20 carbon atoms, or an alkylamino group having 1 to 2 carbon atoms; and R⁸ is an optionally substituted alkylene group having 1 to 20 carbon atoms, an optionally substituted alkenylene group having 2 to 20 carbon atoms, an optionally substituted heterocyclic group with 3 to 15 carbon atoms, optionally substituted arylene group having 6 to 15 carbon atoms and an optionally substituted cycloalkylene group having 3 to 12 carbon atoms; wherein the alkylene group, alkenylene group, heterocyclic group, arylene group, or cycloalkylene group can be substituted with 1 to 4 substituents independently selected from the group consisting of a halogen, hydroxy, amino, nitro, cyano, carboxy, an alkyl group having 1 to 20 carbons, a heterocyclic group having 3 to 16 carbons, and an alkoxy group having 1 to 20 carbon atoms.

2. The polyimide or polyamic acid of claim 1, wherein:
R and R¹ are each independently selected from the group consisting of:
hydrogen, an optionally substituted alkyl group having 7 to 20 carbon atoms, an optionally substituted alkene group having 3 to 20 carbon atoms, an optionally substituted cycloalkyl group having 3 to 12 carbon atoms and
a phenyl group of the following structure: 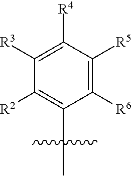
wherein the alkyl group, alkene group, or cycloalkyl group can be substituted with 1 to 5 substituents independently selected from the group consisting of a heterocyclic group having 3 to 16 carbons, a hydroxyl group, and an alkoxy group having 1 to 20 carbon atoms;
wherein 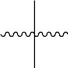
represents the attachment point to the methylene carbon bridging the furan rings in Formula (I); R², R³, R⁴, R⁵, and R⁶ are independently selected from the group consisting of hydrogen, a hydroxyl group, an alkoxy group having 1 to 20 carbon atoms, an optionally substituted alkyl group having 1 to 20 carbon atoms, an optionally substituted alkene group having 2 to 20 carbon atoms, an optionally substituted aryl group having 6 to 10 carbon atoms, an optionally substituted heterocyclic group having 3 to 9 carbon atoms, and an optionally substituted cycloalkyl group having 3 to 12 carbon atoms; wherein the optionally substituted alkyl group, alkene group, aryl group, heterocyclic group, or cycloalkyl group can be substituted with 1 to 5 substituents independently selected from the group consisting of a hydroxyl group, an alkoxy group, and a heterocyclic group having 1 to 20 carbon atoms; wherein at least one of R², R³, R⁴, R⁵ and R⁶ is not a hydrogen when one of R and R¹ is hydrogen, and
wherein only one of R and R¹ can be a hydrogen.

3. The polyimide or polyamic acid of claim 1, wherein:
R is hydrogen; R¹ selected from a phenyl group of the following structure: 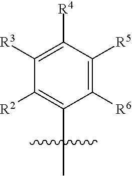
wherein 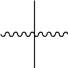
represents the attachment point to the methylene carbon bridging the furan rings in Formula (I); R², R³, R⁴, R⁵, and R⁶ are independently selected from the group consisting of hydrogen, a hydroxyl group, an alkoxy group having 1 to 4 carbon atoms, an alkyl group having 1 to 6 carbon atoms, and an alkene group having 2 to 4 carbon atoms; wherein at least one of R², R³, R⁴, R⁵ and R⁶ is not a hydrogen.

4. The polyimide or polyamic acid of claim 1, wherein:
R and R¹ are each independently selected from the group consisting of:
hydrogen, an optionally substituted alkyl group having 8 to 18 carbon atoms, an optionally substituted alkene group having 4 to 18 carbon atoms, and an optionally substituted cycloalkyl group having 3 to 8 carbon atoms, wherein the alkyl group, alkene group, or cycloalkyl group can be substituted with 1 to 5 substituents independently selected from the group consisting of a halogen, hydroxy, amino, nitro, cyano, carboxy, an alkyl group having 1 to 8 carbons, and an alkoxy group having 1 to 8 carbon atoms; and
only one of R and R¹ can be a hydrogen.

5. The polyimide or polyamic acid of claim 1, wherein the furfurylamine compound is a tetrafuran tetramine compound of Formula (II): 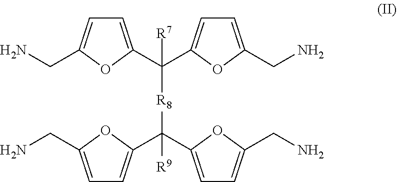
wherein R⁷ and R⁹ are independently selected from the group consisting of hydrogen, an optionally substituted alkyl group having 1 to 18 carbon atoms, an optionally substituted alkene group having 2 to 18 carbon atoms, an optionally substituted heterocyclic group with 3 to 8 carbon atoms, an optionally substituted aryl group having 6 to 9 carbon atoms and an optionally substituted cycloalkyl group having 3 to 12 carbon atoms; wherein the alkyl group, alkene group, heterocyclic group, aryl group, or cycloalkyl group can be substituted with 1 to 5 substituents independently selected from the group consisting of a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms; and
R⁸ is selected from the group consisting of an optionally substituted alkylene group having 1 to 18 carbon atoms, an optionally substituted alkenylene group having 2 to 18 carbon atoms, an optionally substituted heterocyclic group with 3 to 8 carbon atoms, an optionally substituted arylene group having 6 to 9 carbon atoms and an optionally substituted cycloalkylene group having 3 to 12 carbon atoms; wherein the alkylene group, alkenylene group, heterocyclic group, arylene group, or cycloalkylene group can be substituted with 1 to 4 substituents independently selected from the group consisting of a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms.

6. The polyimide or polyamic acid of claim 1, wherein the furfurylamine compound is a tetrafuran tetramine compound of Formula (II): 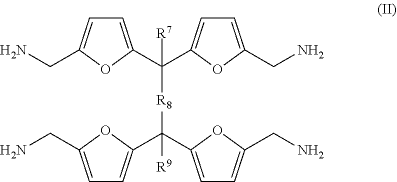
wherein R⁷ and R⁹ are independently selected from the group consisting of hydrogen, an optionally substituted alkyl group having 1 to 8 carbon atoms, an optionally substituted alkene group having 2 to 8 carbon atoms, an optionally substituted heterocyclic group with 3 to 6 carbon atoms, an optionally substituted aryl group having 6 to 9 carbon atoms and an optionally substituted cycloalkyl group having 3 to 8 carbon atoms; wherein the alkyl group, alkene group, heterocyclic group, aryl group, or cycloalkyl group can be substituted with 1 to 5 substituents independently selected from the group consisting of a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms; and
R⁸ is selected from the group consisting of an optionally substituted alkylene group having 1 to 8 carbon atoms, an optionally substituted alkenylene group having 2 to 8 carbon atoms, an optionally substituted heterocyclic group with 3 to 6 carbon atoms, optionally substituted arylene group having 6 to 9 carbon atoms and an optionally substituted cycloalkylene group having 3 to 8 carbon atoms; wherein the alkylene group, alkenylene group, heterocyclic group, arylene group, or cycloalkylene group can be substituted with 1 to 4 substituents independently selected from the group consisting of a halogen, hydroxy, amino, nitro, cyano, carboxy, an alkyl group having 1 to 8 carbons, an alkoxy group having 1 to 8 carbon atoms, and a heterocyclic group having 3 to 10 carbon atoms.

7. The polyimide or polyamic acid of claim 1,
wherein in R, R¹, R², R³, R⁴, R⁵, R⁶, R⁷ and R⁹
the alkyl group is selected from the group consisting of a straight or branched chain butyl, pentyl, hexyl, heptyl, octyl, nonyl, decyl, undecyl and dodecyl,
the alkene group is selected from the group consisting of a vinyl, propenyl, or a straight or branched chain butenyl, pentenyl, hexenyl, heptenyl, octenyl, nonenyl, decenyl, undecenyl and dodecenyl,
the cycloalkyl group is selected from the group consisting of a cyclopentyl and a cyclohexyl,
the aryl group is selected from the group consisting of a phenyl, tolyl, and biphenyl,
the heterocyclic group is selected from the group consisting of pyrrolidine, pyrrole, tetrahydrofuran, furan, tetrahydrothiophene, thiophene, imidazolidine, pyrazolidine, imidazole, pyrazole, oxazolidine, isoxazolidine, oxazole, isoxazole, thiazolidine, isothiazolidine, thiazole, isothiazole, dioxolane, dithiolane, piperidine, pyridine, bipyridine, tetrahydropyran, pyran, piperazine, diazines, morpholine, oxazine, thiomorpholine, and thiazine;
wherein in R⁸
the alkylene group is selected from a straight or branched chain butylene, pentylene, hexylene, heptylene, octylene, nonylene, decylene, undecylene and dodecylene,
the alkenylene group is selected from the group consisting of a vinylene, propenylene, or a straight or branched chain butenylene, pentenylene, hexenylene, heptenylene, octenylene, nonenylene, decenylene, undecenylene and dodecenylene, the cycloalkylene group is selected from the group consisting of a cyclopentylene and a cyclohexylene,
the arylene group is selected from the group consisting of phenylene, tolylene, and biphenylene; and
wherein the groups are optionally substituted with 1-4 substituents and the optional substituents are selected from the group consisting of an alkyl group having 1 to 3 carbons, an aldehyde, a hydroxyl group and methoxy group.

8. The polyimide or polyamic acid of claim 1, wherein there is a 1:2 to 2:1 molar ratio of the one or more difuran-diamine monomers to the one or more dianhydride or diacid compounds.

9. (canceled)

10. The polyimide of claim 1, comprising at least one repeat unit of Formula (III): 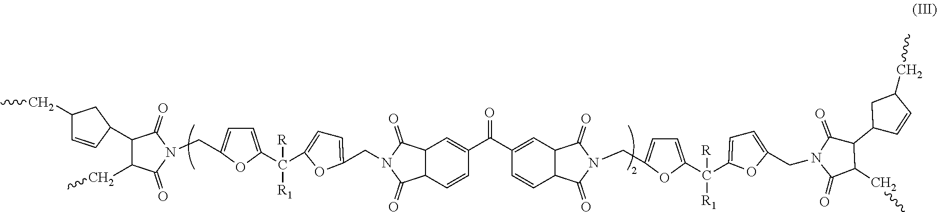
wherein R and R₁ are defined in claim 1; and the symbol [symbol] denotes a covalent bond to another repeat unit.

11. The polyamic acid of claim 1 having the following Formula (IV): 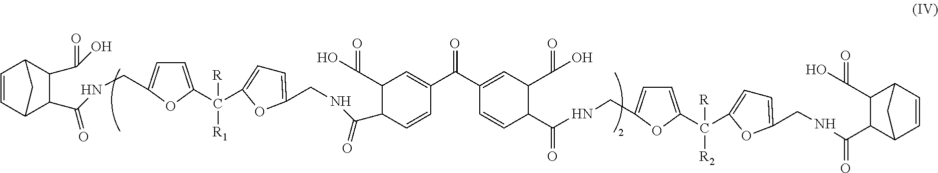
wherein R and R₁ are as defined in claim 1.

12. A method of forming the polyimide or polyamic acid of claim 1, comprising combining,
one or more furfurylamine compounds of Formula (I) or Formula (II) as defined in claim 1; and
one or more comonomers selected from:
any dianhydride or dimethyl ester thereof including but not limited to 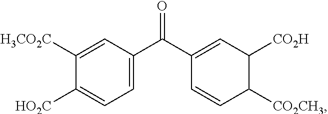 [SMILES: COC(=O)c1cc(C(=O)C2=CC(C(=O)O)C(C(=O)OC)C=C2)ccc1C(=O)O]
3,3′,4,4′-Benzophenonetetracarboxylic dianhydride (BTDA) or diester thereof (BTDE) 3FDA, 4,4′-(2,2,2-trifiuoro-1-phenylethylidene) diphthalic anhydride or dimethyl ester thereof;
PEPA, 4-phenylethynylphthalic anhydride; BPDA, 3,3′,4,4′-biphenyl-tetracarboxylic dianhydride or dimethyl ester thereof; DPEB,3,5-diamino-4′-phenylethynyl benzophenone;
6FDA, 4,4′-(1,1,1,3,3,3-hexafioroisopropylidene) diphthalic anhydride or dimethyl ester thereof; 8FDA, 4,4′-(2,2,2-trifluoro-1-pentafiuorophenylethylidene) dipthalic anhydride;
BTDA, 3,3′-4,4′-benzophenone tetracarboxylic acid dianhydride or dimethyl ester thereof;
BNDA, 4,4-bis (1,1-binapthyl-2-oxy, 1,1′-binepthyl-2,2′-oxy) dipthalic anhydride or dimethyl ester; BAPPNE, dimethyl ester of 5-norbornene 1,2-dicarboxylic acid;
PBDA, 4,4′-(1,1′-biphenyl-2-oxy) diphthalic anhydride or dimethyl ester thereof;
BPADA, 2,2′-bis(phenoxy isopropylidene) 4,4′-diphthalic anhydride;
Bisphenol A-4,4′-diphthalic anhydride; PDMDA, 3,3′-bis (3,4-dicarboxyphenoxy) diphenylmethane dianhydride; and 2,2′,-BPDA, 2,2′,3,3′,-biphenyltetracarboxylic dianhydride or dimethylester thereof; and
optionally any unsaturated mono anhydride or methyl ester thereof; including but not limited to: 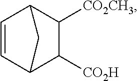 [SMILES: COC(=O)C1C2C=CC(C2)C1C(=O)O]
nadic anhydride (NA) or methyl ester (NE) thereof; phenylethynyl, maleic anhydride, acetylene functionalized anhydride or methyl ester thereof; vinyl functionalized anhydride or methyl ester thereof; nitrile containing anhydride or methyl ester thereof; phenylacetylene containing anhydride or methyl ester thereof, phathalonitrile containing anhydride or methyl ester thereof, biphenylene containing anhydride or methyl ester thereof, and benzocylobutene containing anhydride or methyl ester thereof, and
heating to a temperature of up to 350° C.

13. The method of forming the polyimide or polyamic acid according to claim 12, wherein the one or more furfurylamine compounds of Formula (I) or Formula (II) and dianhydride monomers are heated in the presence of at least one organic solvent selected from the group consisting of dimethylacetamide, acetonitrile, ethyl acetate, isopropyl acetate, hydrocarbon alcohols, polar substances, aromatic hydrocarbons, organic ethers, ketone hydrocarbons, hydrocarbons containing chlorine, furan hydrocarbons, and mixture thereof.

14-16. (canceled)

17. The method of forming the polyamic acid according to claim 12, further comprising a step wherein the one or more furfurylamine compounds of Formula (I) or Formula (II), NE and BTDE combine to form the polyamic acid of Formula (IV): 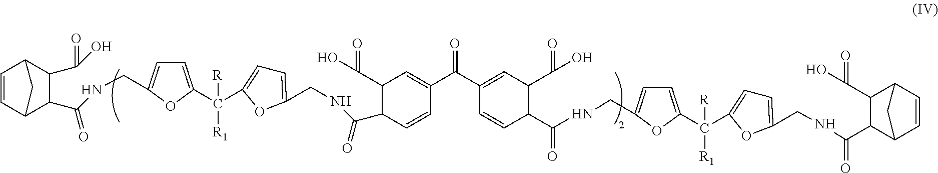
wherein R and R₁ are as defined in claim 1.

18. A method of forming a polyimide, comprising removing water and methanol from the polyamic acid of claim 17 to form an intermediate of Formula (V) 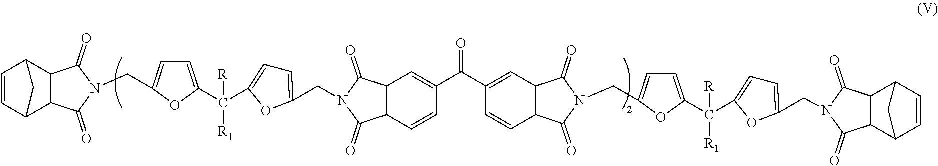
wherein R and R₁ are as defined in claim 1.

19. The method of forming the polyamic acid according to claim 12, further comprising a step wherein the one or more furfurylamine compounds of Formula (I) or Formula (II), and one or more comonomers which are dianhydrides or methyl esters thereof combine to form the polyamic acid while using stoichiometric ratios of anhydride/methyl anhydride relative the amine to produce a linear polymer with molecular weight of 10,000 g/mol or higher.

20. A method of forming a polyimide, comprising removing water and methanol from the polyamic acid of claim 19 to form a linear polyamide with molecular weight of 10,000 g/mol or higher.

21. The method of forming the polyimide according to claim 20, further comprising a step of conversion of the intermediate of Formula (V) to the polyimide of Formula (III) with heat, or at a temperature of 100-315° C.

22-23. (canceled)

24. The method of forming the polyamic acid according to claim 11, further comprising a step of forming BTDE by combining 3,3′,4,4′-benzophenonetetracarboxylic dianhydride with methanol or anhydrous methanol.

25. The method according to claim 13, wherein the NE, the one or more furfurylamine compounds of Formula (I) or Formula (II) and BTDE are combined in a ratio of about 2:3.087:2.087.

26-27. (canceled)

28. A polymer composition comprising the polyimide or polyamic acid of claim 1, and further comprising one or more of fibers, clays, silicates, fillers, whiskers, pigments, corrosion inhibitors, flow additives, film formers, defoamers, coupling agents, antioxidants, stabilizers, flame retardants, reheating aids, plasticizers, flexibilizers, anti-fogging agents, nucleating agents, and combinations thereof.

29. (canceled)
